(19) United States
(12) Patent Application Publication
(10) Pub. No.: US 2001/0032131 A1
(43) Pub. Date: Oct. 18, 2001

(54) Electronic, public addressing visual display network

(76) Inventor: Craig Mowry, Southampton, NY (US)

Correspondence Address: CRAIG MOWRY, 95 SOUTH MAIN ST., SOUTHAMPTON, NY, 11968, US

(21) Appl. No.: 09/756,278

(22) Filed: Jan. 9, 2001

Related U.S. Application Data
(60) Provisional application No. 60/174,838, filed on Jan. 7, 2000.
(60) Provisional application No. 60/176,543, filed on Jan. 18, 2000.
(60) Provisional application No. 60/196,932, filed on Apr. 13, 2000.

(51) Int. Cl. G06F 17/60

(52) U.S. Cl. 705/14

(57) ABSTRACT

The present invention in the preferred configuration includes a network of video monitors placed in public spaces, such are retail establishments. These monitors are provided with final image display data from a locally connected computer, or data receiving, storage, processing and relaying for display means. Each of these monitor and computer combination units, may be individually addressed from a single transmission facility, allowing for unique programming on each monitor.

Selected participants in this network, such as retailers who are featuring said monitors within their establishments, may provide visual content data through the Internet, for potentially immediate display on a selected number of monitors within the network, for a select ordered duration and display period. Further, rectangular plasma monitors may allow for monitors to be positioned vertically, (on end,) or horizontally, to allow for variation in the image display options proportionally. Further, advertising and public announcement matter provided as still image or streaming video data may be displayed in discreetly targeted areas and time periods, bringing the threshold of cost in buying “out of home media” down to very low rate possibilities, as a single monitor may display a selected advertisement for 10 seconds a day, only, for example.

### BACKGROUND OF THE INVENTION

The marketing world continues to strive for new venues of exposure for brands to become both seen and remembered; the challenge is to get the duration of attention from the viewer required for the image to have its best chance of being retained by the viewer, and potential consumer.

Current OUT-OF-HOME media is costly and in great demand; it is also limited by the fact that is it typically displayed in areas where viewers are in motion and perhaps overly stimulated, by other existing visuals, to pay adequate attention to the advertised images, (also referred to as OUTDOOR MEDIA.) Further, certain markets, including MANHATTAN, are unable to accommodate enough visuals within the dynamics of zoning, to satisfy the current demand. Therefore, OUT-OF-HOME advertisers in certain markets are potentially overcharged for the value of the media “per thousand actual viewers,” relative to other media venues, and under-served by this media venue, only being able to utilize this marketing option as space becomes available. In addition, current technology allows for flat video monitors to now serve as visual display devises that may fulfill both practical and revenue bearing purposes, for both the locations in which they may be housed and the entity supplying the programming to these monitors. A newly provided and programmed multimedia venue may blur the line between outdoor media and television, providing new services and revenue potential to businesses and institutions already in place.

### OBJECT OF THE INVENTION

The present invention provides means for new OUT OF HOME advertising options, including the electronic visual display of still images and real time video matter inside publicly frequented spaces. The present invention also provides means for cable television providers to further exploit the use of their existing cable networks, by allowing for monitors in places of business specially programmed with new venues of advertising able to be sold and supplied over their existing network, by monitor specific addressable programming means. The present invention further provides means for business establishments to have their in-store, or point of purchase, display needs handled by a visual display monitor which is serving a secondary purpose of featuring advertising, similarly, means are provided for businesses to acquire valuable advertising and marketing exposure in other public places, simply by housing monitor(s) within their own place of business, in lieu of direct spending for advertising. Further, the present invention provides a valuable product sampling marketing program and means to acquire marketing exposure for a selected plasma screen monitor maker. This maker could acquire exposure on a network of publicly viewed plasma screen monitors in exchange for the units, the monitor maker's advertising promoting the fact that the suppliers' product is the actual monitor being viewed.

### PREFERRED EMBODIMENT OF THE PRESENT INVENTION

Current trends and capabilities allow for monitors within a “cable TV” network to be individually addressable, such as with PAY-PER-VIEW programs, thus each monitor can potentially be its own individually programmed “TV STATION” today. The increased number of possible “channels” within a cable system also provides a multitude of unique programming venues provided simultaneously by a single system. Though this is not a feasible option to exploit relative to each individual viewing household, it is a dynamic that serves the application of the current invention extremely well. Also, the internet is also providing ever improving options for real time video transmission designated by internet sites, allowing for an internet address to serve as a data source much the way a television channel provides a single unique stream of linear programming.

Plasma “flat screen” monitors now provide a powerful visual option allowing for still and real time video, and taking up almost no space dept-wise, creating new versatility for the moving image in restricted space zones, such as places of business. A new opportunity to bring “out of home” and television advertising, (among other options,) in to public places including interiors of business, is provided by the present invention.

Utilizing a unique cross marketing approach and application, a potentially large number of “flat screen” plasma monitors may be situated in many businesses and busy interior locations in key markets, where potential consumers are moving more slowly than when outdoor; in many cases, this slow movement may be caused by a line of people or otherwise motion restricted zone. In these situations, people tend to actually seek visuals to distract their attention from their delayed circumstance. In providing these monitors which may display both still images and real time video material, advertisers of television, outdoor and print media may find a new home for their creative and message, broadening their reach to extremely targeted and selectable groups of people in selected establishments. From banks, to rent-a-car lines, to Hotels and beyond, the possible locations for these networked monitors is virtually unlimited.

Beyond the opportunity for direct advertising on these monitors, this invention includes a unique cross marketing aspect powered by this new electronic network; this cross marketing program being potentially integral in making the system logistically feasible in the current marketing environment: By acquiring locations for the monitors all or in part through advertising the businesses accommodating these monitors on other monitors in non-competitive business locations, new business can be drawn to the primary business; marketing efforts can be enhanced with no cash expenditure, simply by way of a willingness to house a monitor to the terms of the cross-marketing network of the present invention.

Further, the monitors may provide important product, service and PR information about the primary business allowing the monitors to serve a VISUAL DISPLAY purpose to the businesses where they are situated, augmenting or eliminating posters and other displays that required space and production expense, in essence, helping to drive the sales of the establishments in which they are situated. This as a further aspect of the cross-marketing program of the invention.

In providing the needed visuals on a current basis for the businesses at no expense, (potentially occupying a large amount of the available time on these monitors,) they become “location friendly” and not simply an advertising venue within a location. For instance, a coffee shop may feature the various beverages they provide visually, as well as sweepstakes their company may be running as incentives to coffee buyers; a rent-a-car firm might visually display the models of cars they are promoting for rental, aside from the hotels or other advertising clients that may appear on monitors at their car rental locations. Naturally, if HOLIDAY INN is appearing on the ALAMO RENT-A-CAR monitors, they could either be a paying advertiser or perhaps another firm providing locations for other monitors to be situated; this marketing aspect is an option to exploit the value of the network exposure to further the reach of the network, in lieu of direct spending to do so.

For a PLASMA TV MANUFACTURER, the current invention might allow for an incredibly powerful marketing opportunity, whereby they provide their particular product for the network in bulk, in exchange for a volume of on-monitor exposure for their product; in a highly competitive electronics market, having hundreds or thousands of their units actually seen and experienced by perhaps millions of consumers is invaluable. Seeing a monitor in a magazine or on another television as a commercial, simply does not equate to seeing the actual unit, and on the unit being solicited to get information about the unit the viewer is seeing.

Related to the plasma monitors being used as the visual display means of this system and method, further options are provided by the configuration of the present invention, including: To allow for flexibility in accommodating not only motion and still image creative, the plasma monitors may be situated horizontally or vertically, selectively, to provide monitors within a network based on the present invention that are better suited to accommodate creative of dimensions more suited for a taller “vertical” display shape, or a horizontal shape, much like the difference in dimension between a single page in a magazine, and a double page spread. Further, as a further aspect of the multi-level cooperative provided by the present invention, the monitors may selectively feature “margins” on the top and/or bottom of screen, or the sides (one or both,) to allow for selectively continual exposure for selected firms' promotions, such as the name and/or website text of an owner of the monitor network, and the name and/or web address of the flat screen monitor provider, etc. In essence, the “margin” format provides a continual “banner” format for selective promotion, beyond the visuals which run in the main portion of the monitor screens.

For a CABLE OPERATOR, for example, (should they be the primary firm to house the present invention,) this proposed marketing network provides a further means for them to derive revenue from their existing network of lines and connections, laid at great. Virtually no additional hardware would be required for a regional CABLE OPERATOR to allow for this network of visual display monitors; there is indeed a programming effort and requirement for the ability to receive and allocate media from establishments and advertisers in accordance with agreements, but CABLE OPERATORS do this currently in handling PAY PER VIEW requests from cable system clients. The present invention involves simply an extension of that venue of service logistically. The network of the present invention is not dependent on cable systems or MSO's (multi system operators,) though, as clearly internet transmission means and broadcasting options including cellular telephone technology and microwave transmissions may provide digital data to allow for the network of the present invention; even a wireless network is thus very feasible.

Through the cross marketing possibilities detailed in the present invention, the CABLE OPERATOR, or entity providing this new network, could thus avoid having to purchase the display monitors through a proper coop arrangement with an plasma monitor vendor. The cable operator can further avoid, or reduce, direct costs of placement of the monitors by way of the marketing coop program described herein. And, a cable operator who is always striving for more advertising on their current programming locally can now sell and accommodate both TV and still image advertisers, penetrating in to the OUT-OF-HOME and print media market by utilizing the existing cable network lines and/or hardware and distribution means in place, and the marketing method detailed in the present invention.

It should be noted that ongoing upgrades to the versatility of the monitors of the present invention could include touch-screen interactive capability to allow viewers to prompt selective information, connections to selected internet resources selectably, among other applications with changes in normal uses of monitors and computers as time goes on. The monitors themselves could eventually be replaced with more advanced units capable of new forms of visual display and interactivity not yet available broadly.

In the preferred configuration of the present invention, a “network” of visual display units (monitors) would receive their visual content from a cable television provider (CTP,) or multi-system-operator (MSO,) in the cable television industry; the type of firm that owns and/or controls the wiring withn a city, for instance, that provides multi-channel television programming in to homes and other places where television is viewed.

The visual display units would be rectangular plasma screen “flat” monitors, allowing for a large visual area for display without requiring significant space allocation where the monitors are selected to occur. These locations where monitors would occur would most predominantly be places of business where the public buys items, eats, is entertained or must wait in line for certain services. These places of business would have the option of using the monitors as visual display devices for their own “point of purchase” or other internal marketing needs; this might include products or services for sale at the location where a given monitor is situated. Further, these places of business as “components of the network,” may provide space for monitors to occur within their establishments, in exchange for valuable exposure for their business, products or services on other monitors within the network where the public may be exposed to their name, brand, products or other desired message.

The programming that a given business might want to have displayed on monitors within their establishments or other agreed “network” locations where monitors are situated, would easily be supplied to the CTP electronically, for instance as a visual or piece of video data transmitted via the internet or through other familiar immediate data relaying options; within the specs of what the CTP would require for supplied art for display, images and matter would be potentially transmitted and displayed on selected monitors in the network with remarkable speed. The speed with which the visuals supplied could be supplied to the network is an aspect of the network that is novel; current options for OUT OF HOME media require significant lead time for physical creation and distribution of visuals before the public can experience the visuals, which in many cases are time sensitive in nature.

Naturally, the monitors of the network would further provide very valuable advertising opportunities unique to the network. Both still images, multiple still images telling a “story” and real time video matter, as well as electronically generated content (words, statements, etc.,) could be displayed to the public through the video monitors of the network. Currently, CTP's and MSO's who have invested enormously in their wiring networks within regions, are limited to displaying advertising on a broadly targeted basis to homes; the network of the present invention allows for far more specific targeting of the public for advertisers and further provides the powerful option of featuring advertising typically restricted to magazines and print media, or OUT OF HOME. With the visuals of the “place of business” where a monitor is located functioning as the “editorial content” and the other advertising visuals service as the “advertising content” of the programming, a further benefit would naturally be that the CTP would not have to create or purchase programming to display on the monitors to hold audience interest to sell ad time, or to attain ratings thresholds. Typical rules of programming would not apply, as the units would not be “television programming” devises, but OUT OF HOME visual display units. As a further benefit to the network providing CTP, the monitors themselves would best be provided by a vendor who would benefit and be interested in promotion on the units for the plasma monitors themselves; in a highly competitive technology industry, this valuable product-sampling promotion involving the units themselves as the demo and content on the units as the marketing devise, monitors should be attainable for the network strictly as a barter deal within the cross marketing program of the present invention.

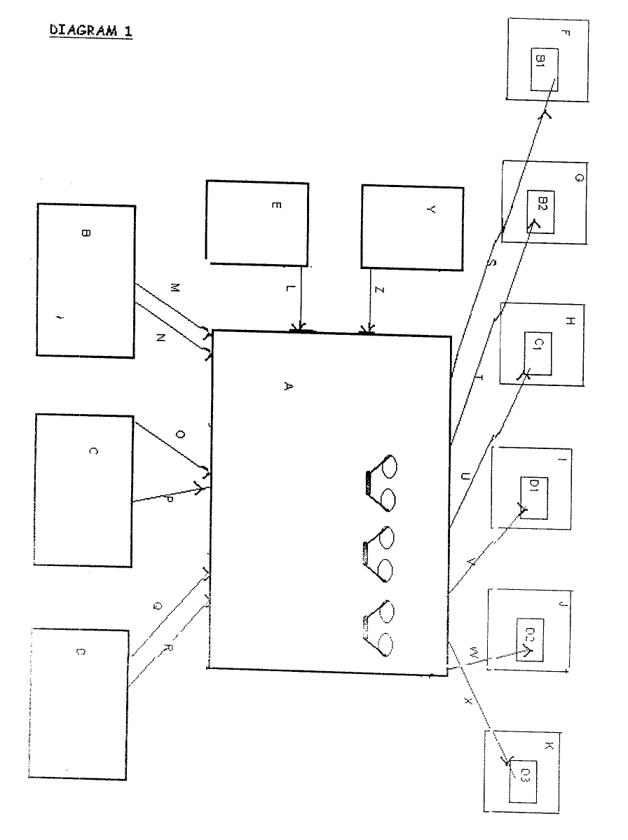

### REFERRING TO FIG. 1

A: The HEAD END facility and coordinating/programming heart of the network, whether internet based, cable television based or other.

B: A client with places of business where a monitor of the network is situated.

C: A client with places of business where monitors of the network are situated.

D: A client with places of business where monitors of the network are situated.

E: An advertiser who has paid “A” to run real time video advertising on selected network monitors. This advertiser does not accommodate any network monitors at any locations

F: A coffee shop owned by client “B” (above,) where a monitor of the network is placed.

G: A music store owned by client “C” (above) where a monitor of the network is placed.

H: A music store owned by client “C” (above) where a monitor of the network is placed.

I: A hotel owned by client “D” (above) where a monitor of the network is placed.

J: A rent-a-car facility owned by client “D” (above) where a monitor of the network is placed.

K: A public garage owned by client “D” (above) where a monitor of the network is placed.

L: Video material supplied as a digital internet transmission, from ad client “E” to head-end “A.”

M: Still image data from client “B” to promote items on monitor B1 that are unique to store “F.”

N: Still image digitized material supplied electronically by client “B” to head-end “A” to be featured on monitors C1 and C2; full payment from “A” for accommodating monitor B1 within B's retail facility “F”, is this featuring of “B's” supplied material on these other network monitors, allowing “B” to promote that client's chain of coffee shops.

O: Still image and video data supplied electronically by client “C” for playing in both of “C's” record store locations, this supplied content advertising hot CD's happens to be identical for both stores.

P: Real time video data supplied by client “C” for display on network monitors B1 and D1, “A” displaying this video from “C” as partial compensation to “C” for accommodating network monitors C1 and C2 within the record stores owned by “C,” designated by “G” and “H.”

Q: Still image and video data supplied electronically by client “D” for playing in “D's” property locations, this supplied content advertising D's other properties, IE garage “K” is advertised with a still image on monitor D2 which is inside rent-a-car facility “J.”

R: Video material supplied by “D” to “A” for featuring promotion of “D's” car rental company on all other network monitors not housed by “D” including monitors in F,G and H; this featured promotion on the other network monitors as full compensation to “D” for housing network monitors which contain advertising for other noncompetitive firms and products, within “D's” retail locations I, J and K.

S, T, U, V, W, X are cable cast video signals from A, each uniquely programmed by A to include selected visuals, and each supplied through “A's” existing coaxial cable network wires in the major city where “A” is the sole cable television provider; monitors B1, C1, C2, D1, D2, and D3 all are equipped with addressable receiver units, to allow for each of them to receive separate transmissions from “A.”

Y: The manufacturer and provider of all of the plasma screen monitors of the network.

Z: The video material, a 60 second television commercial, supplied by “Y” to “A” to be featured 10 times per Hour on every monitor of the network for a year, this featuring of the commercial by “A” as full compensation to “Y” for supplying the monitors of the network.

NOTE: All scenarios above are hypothetical to illustrate possible applications of the components of the present invention . Any instance where “full compensation” or “partial compensation” is mentioned are only example scenarios, and are selectably interchangeable.

What is claimed is:

1. A method for programming an electronic visual display network wherein:
selected video monitors are situated within selected publicly accessible locations and are rendered individually content addressable from a selected transmission facility, said locations selectively including interiors of business establishments;
said monitors are programmed to display programming including content selectively pertaining to the establishments in which said monitors are located;
said programming may be updated immediately on receipt of video data by said transmission facility from selected sources;
sources may supply content, selectively including advertising content, by means including electronic transmission means to said facility;
said sources may designate selected combinations of said monitors for display of said content;
said establishments which house said monitors are selectively rendered providers of content which is displayed on selected monitors located within other establishments, said other establishments selectively including establishments conducting business different from the business of said establishments providing said advertising content.

2. What is claimed is an electronic visual display network,
wherein selected video monitors are situated within selected publicly accessible locations;
wherein said monitors are connected locally to a digital information storage and management device which provides final image data to each of said monitors;
wherein each of said monitors is individually content addressable by a selected transmission facility;
wherein said monitors display programming selectively including content pertaining to the establishments in which said monitors are located,
wherein electronic transmissions from selected sources provide content data, selectively including advertising content, to said facility;
wherein said programming is selectively updated immediately on receipt of data by said transmission facility;
wherein said sources may designate selected combinations of said monitors for display of said content.

3. What is claimed is a system comprising an electronic visual display network,
wherein selected video monitors are situated within selected publicly accessible locations, said locations selectively including interiors of business establishments;
wherein each of said monitors is individually content addressable by a selected transmission facility;
wherein said monitors display programming selectively including content pertaining to the establishments in which said monitors are located,
wherein electronic transmissions from selected sources provide content data, selectively including advertising content, to said facility;
wherein said programming is selectively updated immediately on receipt of data by said transmission facility;
wherein said sources may designate selected combinations of said monitors for display of said content.

4. What is being described herein might also involve monitors which are plasma screen video monitors of a selected size.

5. What is being described herein might also involve means for selected vendors of said network to feature selected advertising content within the content displayed on selected monitors of said network, including said establishments in which said monitors are located.

6. The network as in claim 2, wherein said transmission facility is a regional cable television provider.

7. The network as in claim 2, said transmission facility is an Internet service provider.

8. The network as in claim 2, wherein said internet service provider supplies content for each of said monitors by way of a distinct internet site corresponding to selectively to each of said monitors, or combinations of said monitors.

9. The network as in claim 2, wherein said transmission facility provides content to each of said monitors by providing a distinct channel and programming, said channel for each version of video content desired within said network allowing each monitor within said network to feature uniquely programmed content.

10. The network as in claim 2, wherein said transmission facility may provide said content to said monitors through a plurality of options, including but not limited to coaxial cable transmission, fiber optic cable transmission, cellular transmission and microwave broadcasting.

11. The network as in claim 2, wherein said content may selectively include images displayed for a selected duration, or designated number of video fields.

12. The network as in claim 2, wherein said monitors include touch-screen interactivity means allowing for selective control of programming on said monitors by viewer selection.

13. The network as in claim 2, wherein said monitors are replaced by single or multiple image light box display units in lieu of electronically generated images.

14. The network as in claim 2, wherein said monitors feature visuals that are vertically or horizontally formatted.

15. The network as in claim 2, wherein said monitors feature visuals which selectively occur within the margins of the plasma monitor screens by segregating screen zones.
